(19) United States
(12) Patent Application Publication
(10) Pub. No.: US 2013/0265331 A1
(43) Pub. Date: Oct. 10, 2013

(54) Virtual Reality Telescopic Observation System of Intelligent Electronic Device and Method Thereof

(71) Applicant: NATIONAL APPLIED RESEARCH LABORATORIES, Taipei (TW)

(72) Inventors: Wen-Hong Wu, Hsinchu (TW); Kuo-Cheng Huang, Hsinchu (TW); Chun-Li Chang, Puzi City (TW); Min-Wei Hung, Hsinchu (TW); Wen-Tse Hsiao, Hsinchu (TW)

(73) Assignee: NATIONAL APPLIED RESEARCH LABORATORIES, Taipei (TW)

(21) Appl. No.: 13/800,724

(22) Filed: Mar. 13, 2013

(30) Foreign Application Priority Data
Apr. 9, 2012 (TW) 101112529

(51) Int. Cl. G02B 27/01; G06T 19/00

(52) U.S. Cl. CPC G02B 27/01; G06T 19/006
USPC 345/633; 345/7

(57) ABSTRACT

A virtual reality telescopic observation system of an intelligent electronic device. The virtual reality telescopic observation system includes an electronic device arranged for displaying a virtual image, an engagement slot arranged for movably embedding the electronic device therein and a virtual reality telescopic optical module, including at least one optical lens installed corresponding to the electronic device, arranged for projecting the virtual image displayed by the electronic device into the virtual reality telescopic optical module, such that a viewer views the virtual image displayed by the electronic device from the virtual reality telescopic optical module. Wherein, when the viewer performs a virtual reality telescopic observation, the angle, distance and position of the virtual image displayed by the electronic device are adjusted according to a changing of the field of view made by the viewer.

### CROSS-REFERENCE TO RELATED APPLICATION

This application claims the benefit of Taiwan Patent Application No. 101112529, filed on Apr. 9, 2012, in the Taiwan Intellectual Property Office, the disclosure of which is incorporated herein in its entirety by reference.

### BACKGROUND OF THE INVENTION

1. Field of the Invention

The present invention relates to a virtual reality telescopic observation system and a method thereof, and more particularly to the field of the virtual reality telescopic observation system and method of an intelligent electronic device.

2. Description of Related Art

Virtual Reality (VR) technology is a computer graphic or image synthesis technology to create a virtual environment and virtual object images in the virtual environment can be real images commonly seen by viewers, or the images can direct viewers to view virtual imaginary images. A viewer can wear virtual reality devices such as head mounting display (HMD) or sensing gloves or use a 3D mouse to browse, control or touch the virtual object images. In a virtual reality processing system, computation processing can be performed according to the viewer's conduct to display new virtual object images online or respond to the viewer's conduct. Therefore, the viewer can use the virtual reality processing system to produce immersive feelings and effects, such that the viewer can be immersed and interacted to produce imagination through the viewer's senses.

Since the virtual object image of the virtual reality is only a 2D image or a 3D image, the virtual object image is lack of physical sense when compared with a physical object, and improvements were made in the following prior arts. As disclosed in R.O.C. Pat. No. TW I302675, a 2D virtual object image is displayed in term of time, such that viewers can produce a 3D virtual reality. As disclosed in R.O.C. Pat. No. TW I286715, a method of switching the top view of an image, a 2D image and a 3D image to show the diversity of the virtual reality. As disclosed in R.O.C. Pat. Publication No. TW 200502822, a computer (or PDA) is used to transmit radio frequency to a fixed physical object, such that a virtual object image and the physical object can be corresponsive to each other. After the radio frequency is received, interaction corresponding to the sensing can be achieved, or a physical moving object (such as a toy bear, a toy car or a model) can be installed with a wireless receiver for controlling the physical object through virtual reality remote control, so that a viewer can be immersed and interacted to produce imagination. However, the relative positions of the viewer and the virtual object image will affect the level of immersion directly. For example, if the viewer wears a head mounting display and uses a virtual reality device, and the traveling position of the same virtual object image remains unchanged, and the virtual object image cannot be interacted with the corresponding position, then the viewer cannot be immersed and interacted with the virtual reality to produce imaginations. Similarly, if the viewer changes the posture such as looking downward, turning the head, nod or looking upward and the virtual object image cannot be interacted with the corresponding position, the viewer also cannot be immersed and interacted with the virtual reality to produce imaginations. In recent years, augmented reality (which is also called mixed reality) is developed to provide a more reasonable virtual vision for the real environment. In the augmented reality, a virtual object image generated by a computer is merged into a background image of the real environment for add the virtual object into the real environment, so as to enhance the virtual reality function and the visual recognition of the physical body. As disclosed in U.S. Pat. No. 7,162,054, Japan Pat. No. JP 2005-141433, U.S. Pat. Publication Nos. US2008/0147325 and US 2009/0244097, and R.O.C. Pat. No. TW M369462, technologies for merging photos or labeled identifying elements into augmented reality, or recognizing a viewer's position is disclosed. However, the conventional virtual display device or the conventional optical system of this sort can only provide images at a near position, so that the viewer's eyes will get tired easily, particularly when the virtual image and the physical object are combined, and the virtual image may be distorted easily. Obviously, the effect of the augmented reality is low. In addition, the conventional virtual reality telescopic observation technology has to integrate an image display device, a position and motion sensor and a telescopic optical module into a virtual reality telescopic observation system and requires connecting to an additional external processor to perform image signal processing, so as to produce reasonable and interactive virtual images, and then transmits the images to the image display device of the virtual reality telescopic observation system by a cable or a wireless transmission, such that the communication and coordination between modules and components are difficult and time-consuming, and the portability and convenience of the virtual reality telescopic observation technology are reduced significantly.

Therefore, the present invention provides a virtual reality telescopic observation system and a method thereof that can generate reasonable and interactive virtual images through an intelligent electronic device, and the intelligent image is integrated with a display device and a image projection optical module to project images of a high-resolution image integrated display device into a viewer's eyes, so that the viewer can be immersed with the scenes from the virtual reality telescopic observation, and the virtual reality produces interaction and sensory imagination, and the volume of the virtual reality telescopic observation system can be reduced significantly. What is more, the viewer can use the virtual reality telescopic observation system easily without getting the eyes tired easily.

### SUMMARY OF THE INVENTION

In view of the aforementioned problems of the prior art, it is a primary objective of the invention to provide a virtual reality telescopic observation system of an intelligent electronic device, and the system comprises: an electronic device, for displaying a virtual image; an engagement slot, for movably embedding the electronic device therein; and a virtual reality telescopic optical module, including at least one optical lens, installed corresponding to the electronic device, for projecting the virtual image displayed by the electronic device into the virtual reality telescopic optical module, such that a viewer views the virtual image displayed by the electronic device from the virtual reality telescopic optical module; wherein, when the viewer performs a virtual reality telescopic observation, the angle, distance and position of the virtual image displayed by the electronic device are adjusted according to a changing of the field of view made by the viewer.

Preferably, the electronic device comprises at least one sensing unit, a computing unit and a display unit; the at least one sensing unit comprises a posture sensor, a direction sensor, a position sensor or any combination thereof; the computing unit comprises a central processing unit and a computing database; the posture sensor is provided for sensing posture information of the viewer, and the direction sensor is provided for sensing direction information of the viewer, and the position sensor is provided for sensing position information of the viewer, and the posture information, the direction information, the position information or any combination thereof are transmitted to the central processing unit to perform a computation, and the computing database is used together to generate the virtual image to be transmitted to the display unit, and the virtual image is projected to the virtual reality telescopic optical module.

Preferably, the virtual image is formed by at least one panoramic image, at least one virtual object image, at least one real image or any combination thereof in the computing database.

Preferably, the posture information, the direction information, the position information, or any combination thereof in the computing database to be computed are transmitted to a remote database server synchronously via a wireless transmission, and received synchronously by the computing database via the wireless transmission when the computing is finished by the remote database server, and the virtual image computed by the remote database server is saved into the computing database.

Preferably, the virtual reality telescopic optical module further comprises at least one optical path adjusting element arranged for expanding or reducing the distance between optical axes of left and right eyes of the viewer's left and right eyes in order to match the distance between the left and right eyes of the viewer's left and right eyes.

Preferably, the virtual reality telescopic optical module further comprising at least one optical reflecting element arranged for decreasing the distance between the electronic device and the viewer, such that the center of gravity of the virtual reality telescopic observation system of the intelligent electronic device approaches the geometric center of the virtual reality telescopic observation system of the intelligent electronic device.

Preferably, the virtual reality telescopic optical module further comprises at least one optical path adjusting element arranged for expanding or reducing the distance between optical axes of left and right eyes of the viewer in order to match the distance between the left and right eyes of the viewer

Another objective of the present invention is to provide a virtual reality telescopic observation method of an intelligent electronic device, and the method comprises the steps of: using a computing unit of the electronic device to combine at least one panoramic image, at least one virtual object image, at least one real image or any combination thereof in a computing database of the electronic device to perform a graphic computation to create a virtual image; using a display unit of the electronic device to display the virtual image that is computed by the computing unit, and project the virtual image into the virtual reality telescopic optical module to allow a viewer to view the virtual image from the virtual reality telescopic optical module; using at least one sensing unit of the electronic device to senses posture information, direction information, position information or any combination thereof of the viewer when the viewer performs a virtual reality telescopic observation, and transmits the information to the computing unit, such that the computing unit compares the relative positions between the viewer and the virtual image, so as to generate a relative position condition of the virtual image; using the computing unit to adjusting the angle, distance and position of the virtual image with respect to the viewer according to the relative position condition when the viewer changes the field of view, and then using the display unit of the electronic device to displays the virtual image adjusted by the computing unit, so that the viewer views the adjusted virtual image from the virtual reality telescopic optical module.

Preferably, the at least one sensing unit comprises a posture sensor, a direction sensor, a position sensor or any combination thereof, and the posture sensor is provided for sensing the posture information of the viewer, and the direction sensor is provided for sensing the direction information of the viewer, and the position sensor is provided for sensing the position information of the viewer.

In summation, the virtual reality telescopic observation system and method of the present invention have one or more of the following advantages:

(1) The virtual reality telescopic observation system and method of the present invention can use the intelligent electronic device to generate reasonable and interactive virtual images and combine the intelligent image integrated display device with the image projection optical module to project the images of the high-resolution image integrated display device into a viewer's eyes, so that viewer can be immersed and interacted with the scene of the virtual reality telescopic observation and the virtual reality produces interaction and sensory imagination, and the volume of the virtual reality telescopic observation system can be reduced significantly. What is more, the viewer can use the virtual reality telescopic observation system easily without getting the eyes tired easily.

(2) The virtual reality telescopic observation system and method of the present invention can generate reasonable and interactive virtual images without requiring the connection to an external processor to perform the image signal processing. The invention can transmit the images to the virtual reality telescopic observation system via a wireless transmission immediately, such that the communication and coordination between modules and components are easy and less time-consuming, and thus the virtual reality telescopic observation system of the present invention can improve the portability and convenience of the system.

### BRIEF DESCRIPTION OF THE DRAWINGS

FIG. 1 is a block diagram of a virtual reality telescopic observation system of an intelligent electronic device in accordance with the present invention;

FIG. 2 is a schematic view of a virtual reality telescopic observation system of an intelligent electronic device in accordance with a first preferred embodiment of the present invention;

FIG. 3 is a schematic view of a virtual reality telescopic observation system of an intelligent electronic device in accordance with a second preferred embodiment of the present invention;

FIG. 4 is a schematic view of a virtual reality telescopic observation system of an intelligent electronic device in accordance with a third preferred embodiment of the present invention;

FIG. 5 is a schematic view of a virtual reality telescopic observation system of an intelligent electronic device in accordance with a fourth preferred embodiment of the present invention;

FIG. 6 is a schematic view of a virtual reality telescopic observation system of an intelligent electronic device in accordance with a fifth preferred embodiment of the present invention;

FIG. 7 is a flow chart of a virtual reality telescopic observation method of an intelligent electronic device in accordance with the present invention.

### DETAILED DESCRIPTION OF THE PREFERRED EMBODIMENTS

The technical contents and characteristics of the present invention will be apparent with the detailed description of a preferred embodiment accompanied with related drawings as follows. For simplicity, same numerals are used in the following preferred embodiment to represent respective same elements.

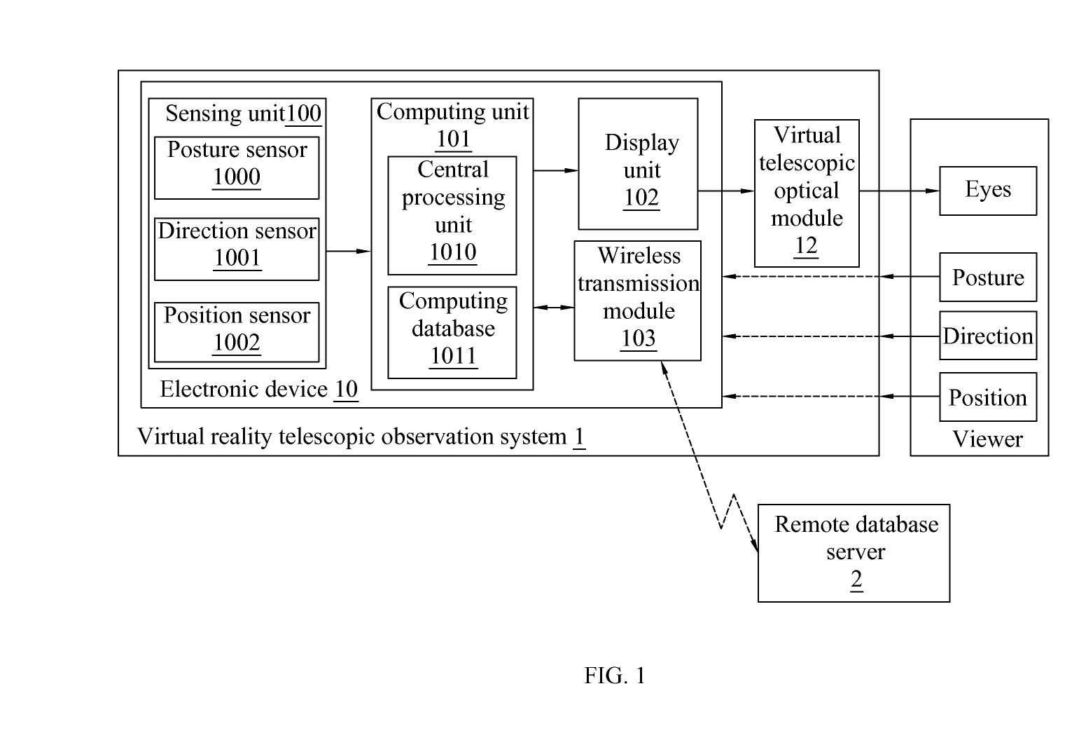

With reference to FIG. 1 for a block diagram of a virtual reality telescopic observation system of an intelligent electronic device in accordance with the present invention, the virtual reality telescopic observation system 1 comprises: an electronic device 10, an engagement slot 11 and a virtual reality telescopic optical module 12. The electronic device 10 is provided for displaying a virtual image; the engagement slot 11 is provided for movably embedding the electronic device 10 into the engagement slot 11; the virtual reality telescopic optical module 12 comprises at least one optical lens 120 installed at a position corresponding to the electronic device 10 for projecting the virtual image displayed by the electronic device 10 into the virtual reality telescopic optical module 12, so that the viewer can view the virtual image displayed by the electronic device 10 through the virtual reality telescopic optical module 12.

In addition, the electronic device 10 further comprises at least one sensing unit 100, a computing unit 101 and a display unit 102; wherein the at least one sensing unit 100 comprises a posture sensor 1000 (such as a gyroscope or gravity sensor), a direction sensor 1001 (such as a surveyor's compass or a digital direction meter), a position sensor 1002 (such as a global positioning system, GPS) or any combination of the above; the computing unit 101 comprises a central processing unit 1010 and a computing database 1011. The posture sensor 1000 is provided for sensing posture information of the viewer, the direction sensor 1001 is provided for sensing direction information of the viewer, and the position sensor 1002 is provided for sensing position information of the viewer. The central processing unit 1010 is provided for performing graphic computation of the virtual image, and the computing database 1011 is provided for storing at least one panoramic image, at least one virtual object image, at least one real image or any combination of the above. In other words, when the viewer makes an observation, the posture information, direction information and position information are transmitted to the central processing unit 1010 of the computing unit 101 to perform computation, and the computing database 1011 of the computing unit 101 is used together to generate a virtual image according to the posture information, direction information and position information of the viewer, and then the virtual image is transmitted to the display unit 102 of the electronic device 10 and projected to the virtual reality telescopic optical module 12. Overall speaking, when the viewer uses the virtual reality telescopic observation system 1 of the present invention to perform a virtual reality telescopic observation, the electronic device 10 can display the virtual image and show the virtual image through the virtual reality telescopic optical module 12. If the viewer changes the angle, distance or position of the field of view, the virtual reality telescopic observation system 1 of the present invention will synchronously sense the viewer's motion to execute a series of computation and project the computed virtual image through the virtual reality telescopic optical module 12 to the viewer, so that the viewer can observe the virtual images while moving and feel the virtual image moving along with the viewer or the virtual image is changed reasonably with the changed posture of the viewer, and thus the invention can enhance the virtual reality effect significantly.

In a preferred embodiment, when the virtual reality telescopic observation system 1 requires to compute a more complicated graphic computation, the computing database 1011 of the computing unit 101 of the electronic device 10 can use a wireless transmission module 103 (such as an infrared, Bluetooth, WIFY, 3G or 4G-LTE wireless transmission system) to synchronously transmit the posture information, the direction information, the position information to be computed or any combination above to the remote database server 20 via a wireless transmission, and after the remote database server 2 performs the more complicated graphic computation, the computed virtual image is transmitted from remote database server 2 to the computing database 1011 via a wireless transmission, and a central processing unit 1010 will project the computed virtual image to the viewer through the virtual reality telescopic optical module 12.

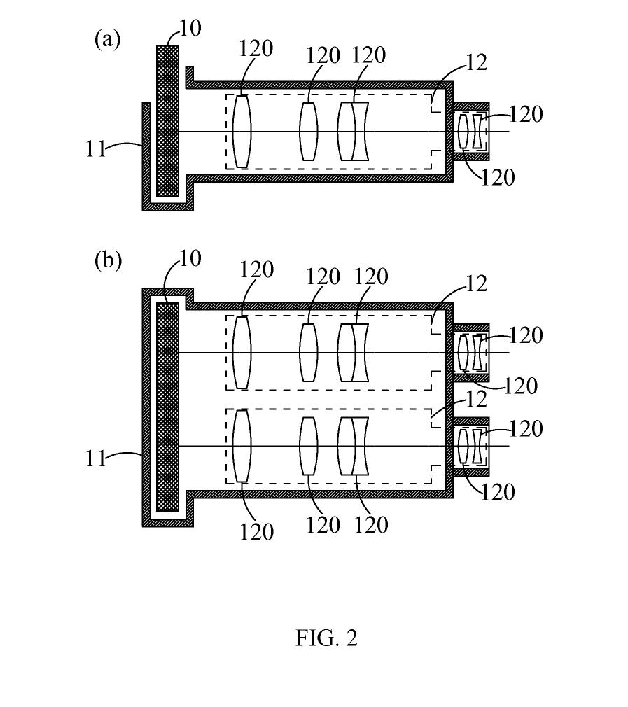

With reference to FIG. 2 for a schematic view of a virtual reality telescopic observation system of an intelligent electronic device in accordance with the first preferred embodiment of the present invention, FIG. 2(a) shows a side view of the first preferred embodiment of the invention, and FIG. 2 (b) shows a top view of the first preferred embodiment of the invention. The electronic device 10 is movably embedded into the engagement slot 11, and the at least one optical lens 120 is arranged parallel to the electronic device 10 to form an optical lens group. For simplicity, six optical lenses 120 for each of the left and right eyes are used as an example for illustrating the present invention, but the invention is not limited to such arrangement only. The virtual image displayed by the electronic device 10 can be projected to the viewer through at least one optical lens 120, such that the viewer can view the virtual image. It is noteworthy that the electronic device 10 can provide two same images with different parallaxes to the left and right eyes of the viewer and projected the two images from the optical lens group to the left and right eyes of the viewer respectively, so that the viewer can view a virtual image with 3D effect, and the viewer can be further immersed into the scene of the virtual image, and the invention can enhance the interactive effect between the viewer and the virtual image substantially.

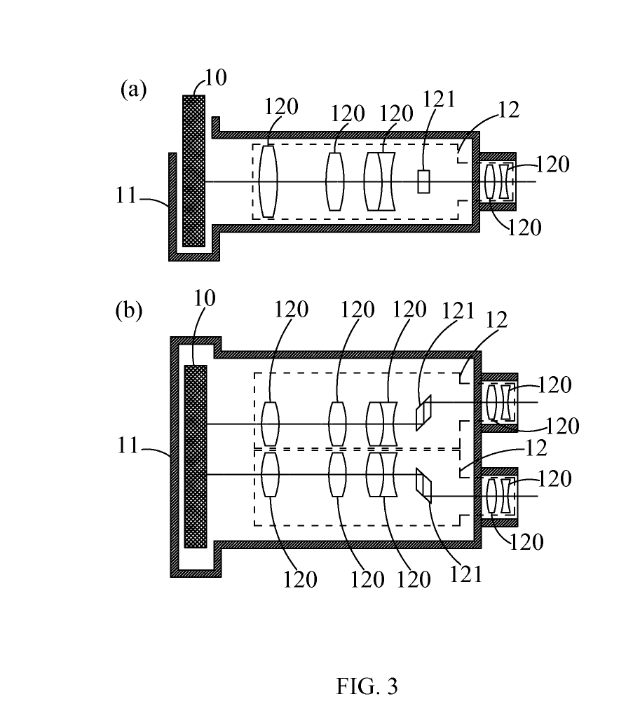

With reference to FIG. 3 for a schematic view of a virtual reality telescopic observation system of an intelligent electronic device in accordance with the second preferred embodiment of the present invention, FIG. 3(a) shows a side view of the first preferred embodiment of the invention, and FIG. 3 (b) shows a top view of the first preferred embodiment of the invention. The effects and functions of the elements with the same respective numerals of this preferred embodiment are similar to those as depicted in FIG. 2, and thus will not be repeated. The difference of this preferred embodiment as shown in FIG. 3 from the illustration of the embodiment as shown in FIG. 2 resides on that this preferred embodiment further comprises at least one optical path adjusting element 121, wherein the optical path adjusting element 121 can adjust the distance between the optical axes of the virtual images of the left and right eyes according to the size of the display unit 102 of the electronic device 10 to match the distance of the eyes of the viewer. In other words, the most appropriate observation for the viewer can be achieved by making the adjustment. It is noteworthy that the optical path adjusting element 121 can be a polygonal prism or a reflecting mirror group. For simplicity, the polygonal prism is used in the preferred embodiment as an example for illustrating the present invention, but the invention is not limited to such arrangement only.

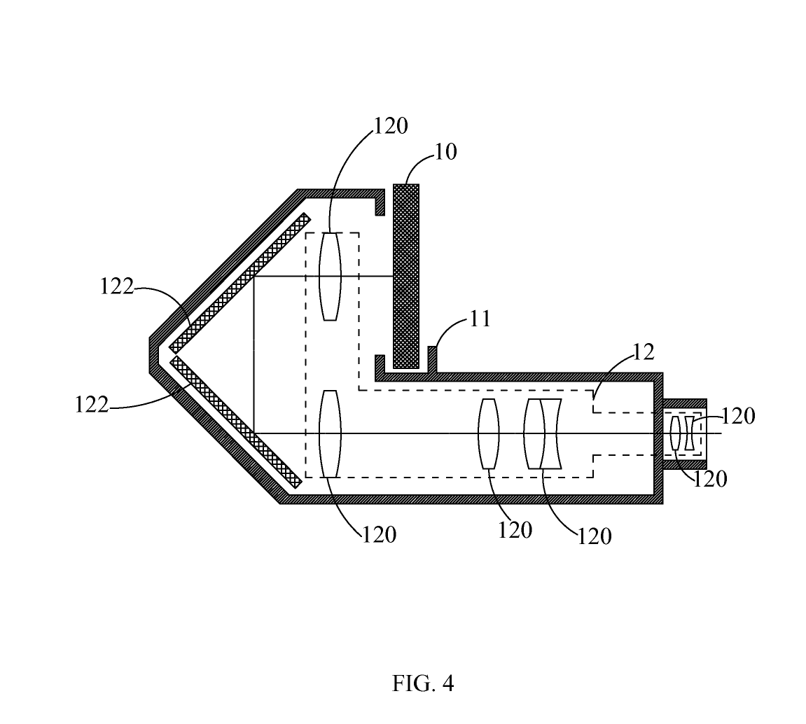

With reference to FIG. 4 for a schematic view of a virtual reality telescopic observation system of an intelligent electronic device in accordance with the third preferred embodiment of the present invention, the effects and functions of the elements with the same respective numerals of this preferred embodiment are similar to those as depicted in FIG. 2, and thus will not be repeated. However, the difference of this preferred embodiment as shown in FIG. 4 from the illustration of the embodiment as shown in FIG. 2 resides on that the virtual reality telescopic observation system 1 as shown in FIG. 4 further comprises at least one optical reflecting element 122 for reducing the distance between the electronic device 10 and the viewer, so that the center of gravity of the virtual reality telescopic observation system 1 can approach the geometric center of the virtual reality telescopic observation system 1, and the viewer can apply a smaller force to use the virtual reality telescopic observation system 1 of the present invention more easily. The invention not only provides an easy way of using the system, but also reduces the applying force for using the system.

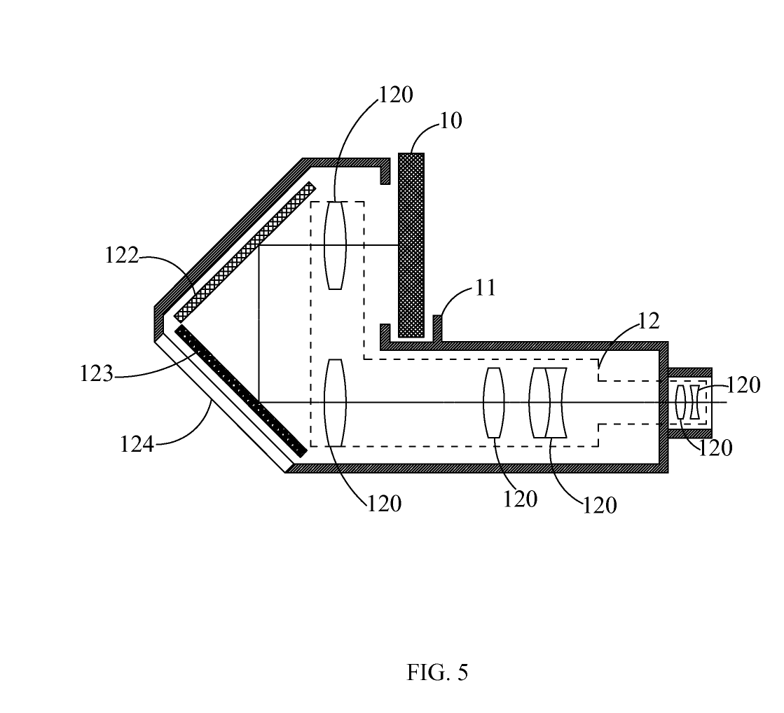

With reference to FIG. 5 for a schematic view of a virtual reality telescopic observation system of an intelligent electronic device in accordance with the fourth preferred embodiment of the present invention, the effects and functions of the elements with the same respective numerals of this preferred embodiment are similar to those as depicted in FIG. 4, and thus will not be repeated. However, the difference of this preferred embodiment as shown in FIG. 5 from the preferred embodiment as shown in FIG. 4 resides on that the virtual reality telescopic observation system 1 of this preferred embodiment further comprises a beamsplitter 123 and a transparent material 124, wherein an external real image enters from the transparent material 124 (or hollow material) through the beamsplitter 123 into the virtual reality telescopic optical module 12, and the external real image computed by the electronic device 10 and combined a virtual object image to form a virtual image, and the virtual reality telescopic optical module 12 provides the virtual images to the viewer, so that the viewer can view the interactive visual effect (including the 2D and 3D interactive visual effect) of the virtual object image on the real image. The invention not only immerses the viewer into the scene of virtual image combined with the real image, but also enhances the fun of the virtual reality significantly.

For example, if the viewer is situated at an ancient Roman arena, the virtual reality telescopic observation system 1 of the present invention will use the sensing unit 100 to determine the direction of the ancient Roman area and the current posture of the viewer according to the geographical position and environment of the viewer and uses the computing database 1011 of the computing unit 101 to access related information of the ancient Roman arena, and then the central processing unit 1010 of the computing unit 101 or the remote database server 2 makes the computation, and transmits the computed result via a wireless transmission to produce reasonable and interactive virtual images, and the virtual reality telescopic optical module 12 projects the virtual image to the viewer, so that the viewer can feel the actual feeling of the ancient Roman arena.

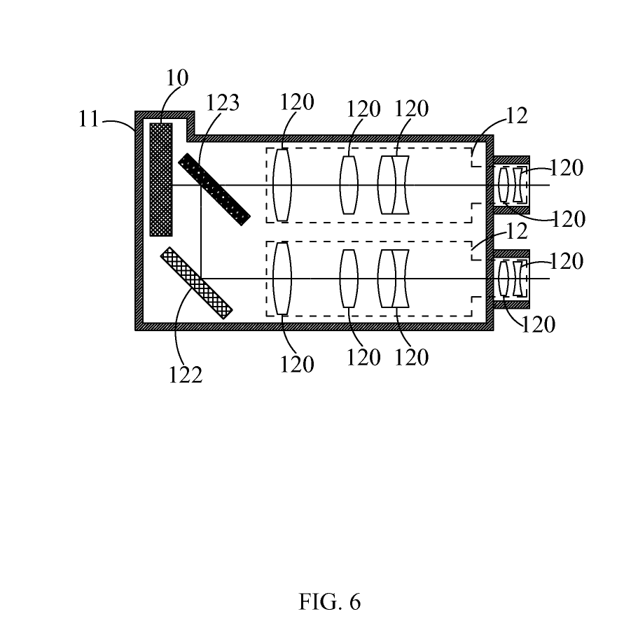

With reference to FIG. 6 for a schematic view of a virtual reality telescopic observation system of an intelligent electronic device in accordance with the fifth preferred embodiment of the present invention, the effects and functions of the elements with the same respective numerals of this preferred embodiment are similar to those as depicted in FIG. 5, and thus will not be repeated. However, the difference of this preferred embodiment as shown in FIG. 6 from the illustration of the embodiment as shown in FIG. 5 resides on that the virtual reality telescopic observation system 1 of this preferred embodiment further comprises at least one optical reflecting element 122 and at least one beamsplitter 123, wherein virtual images projected from a smaller sized display unit 102 of the electronic device 10 can be provided to both left and right eyes of the viewer at the same time. In other words, if the size of the virtual images projected from the display unit 102 of the electronic device 10 is not large enough to fit the distance between the left and right eyes of the viewer, the at least one optical reflecting element 122 and at least one beamsplitter 123 can be used by the viewer to view the virtual images by both eyes.

Even though the concept of the virtual reality telescopic observation method of an intelligent electronic device in accordance with the present invention has been described in the section of the virtual reality telescopic observation system already, the description of the following flow chart is provided for illustrating the present invention more clearly.

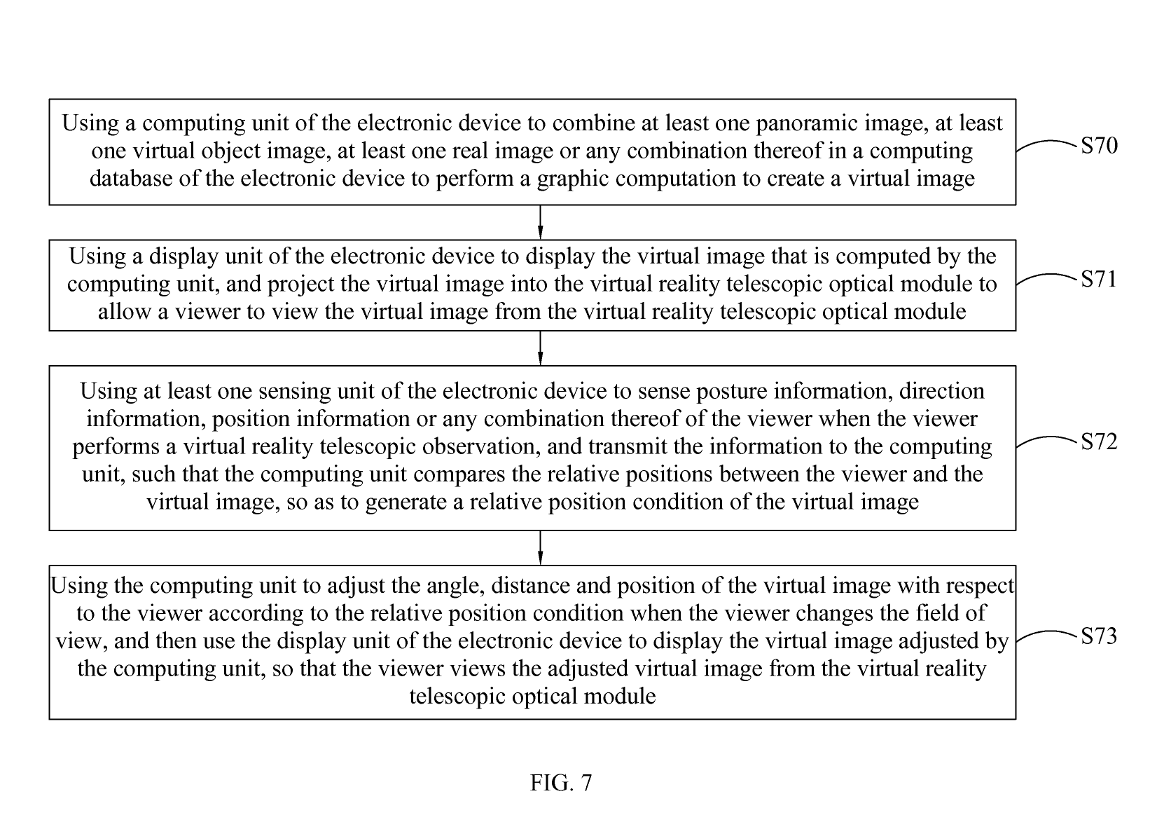

With reference to FIG. 7 for a flow chart of a virtual reality telescopic observation method of an intelligent electronic device in accordance with the present invention, the method comprises the following steps:

S70: Using a computing unit of the electronic device to combine at least one panoramic image, at least one virtual object image, at least one real image or any combination thereof in a computing database of the electronic device to perform a graphic computation to create a virtual image.

S71: Using a display unit of the electronic device to display the virtual image that is computed by the computing unit, and project the virtual image into the virtual reality telescopic optical module to allow a viewer to view the virtual image from the virtual reality telescopic optical module.

S72: Using at least one sensing unit of the electronic device to sense posture information, direction information, position information or any combination thereof of the viewer when the viewer performs a virtual reality telescopic observation, and transmit the information to the computing unit, such that the computing unit compares the relative positions between the viewer and the virtual image, so as to generate a relative position condition of the virtual image.

S73: Using the computing unit to adjust the angle, distance and position of the virtual image with respect to the viewer according to the relative position condition when the viewer changes the field of view, and then use the display unit of the electronic device to display the virtual image adjusted by the computing unit, so that the viewer views the adjusted virtual image from the virtual reality telescopic optical module.

In summation of the description above, the virtual reality telescopic observation system and method of the present invention can achieve the following advantages:

(1) The virtual reality telescopic observation system and method of the present invention can use the intelligent electronic device to generate reasonable and interactive virtual images and combine the intelligent image integrated display device with the image projection optical module to project the images of the high-resolution image integrated display device into a viewer's eyes, so that viewer can be immersed and interacted with the scene of the virtual reality telescopic observation and the virtual reality produces interaction and sensory imagination, and the volume of the virtual reality telescopic observation system can be reduced significantly. What is more, the viewer can use the virtual reality telescopic observation system easily without getting the eyes tired easily.

(2) The virtual reality telescopic observation system and method of the present invention can generate reasonable and interactive virtual images without requiring the connection to an external processor to perform the image signal processing. The invention can transmit the images to the virtual reality telescopic observation system via a wireless transmission immediately, such that the communication and coordination between modules and components are easy and less time-consuming, and thus the virtual reality telescopic observation system of the present invention can improve the portability and convenience of the system.

What is claimed is:

1. A virtual reality telescopic observation system of an intelligent electronic device, comprising:
an electronic device, arranged for displaying a virtual image;
an engagement slot, arranged for movably embedding the electronic device therein; and
a virtual reality telescopic optical module, including at least one optical lens installed corresponding to the electronic device, arranged for projecting the virtual image displayed by the electronic device into the virtual reality telescopic optical module, such that a viewer views the virtual image displayed by the electronic device from the virtual reality telescopic optical module;
wherein, when the viewer performs a virtual reality telescopic observation, the angle, distance and position of the virtual image displayed by the electronic device are adjusted according to a changing of the field of view made by the viewer.

2. The virtual reality telescopic observation system of an intelligent electronic device as recited in claim 1, wherein the electronic device comprises at least one sensing unit, a computing unit and a display unit; the at least one sensing unit comprises a posture sensor, a direction sensor, a position sensor or any combination thereof; the computing unit comprises a central processing unit and a computing database; the posture sensor is provided for sensing posture information of the viewer, and the direction sensor is provided for sensing direction information of the viewer, and the position sensor is provided for sensing position information of the viewer, and the posture information, the direction information, the position information or any combination thereof are transmitted to the central processing unit to perform a computation, and the computing database is used together to generate the virtual image to be transmitted to the display unit, and the virtual image is projected to the virtual reality telescopic optical module.

3. The virtual reality telescopic observation system of an intelligent electronic device as recited in claim 2, wherein the virtual image is formed by at least one panoramic image, at least one virtual object image, at least one real image or any combination thereof in the computing database.

4. The virtual reality telescopic observation system of an intelligent electronic device as recited in claim 3, wherein the posture information, the direction information, the position information, or any combination thereof in the computing database to be computed are transmitted to a remote database server synchronously via a wireless transmission, and received synchronously by the computing database via the wireless transmission when the computing is finished by the remote database server, and the virtual image computed by the remote database server is saved into the computing database.

5. The virtual reality telescopic observation system of an intelligent electronic device as recited in claim 1, wherein the virtual reality telescopic optical module further comprises at least one optical path adjusting element arranged for expanding or reducing the distance between optical axes of left and right eyes of the viewer in order to match the distance between the left and right eyes of the viewer.

6. The virtual reality telescopic observation system of an intelligent electronic device as recited in claim 1, wherein the virtual reality telescopic optical module further comprising at least one optical reflecting element arranged for decreasing the distance between the electronic device and the viewer, such that the center of gravity of the virtual reality telescopic observation system of the intelligent electronic device approaches the geometric center of the virtual reality telescopic observation system of the intelligent electronic device.

7. The virtual reality telescopic observation system of an intelligent electronic device as recited in claim 1, wherein the virtual reality telescopic optical module further comprising a beamsplitter provided for entering a real image into the virtual reality telescopic optical module, such that the real image is combined with a virtual object image to form the virtual image, so as to provide a visual effect of showing the virtual object image on the real image to the viewer.

8. A virtual reality telescopic observation method of an intelligent electronic device, applied in a virtual reality telescopic observation system of the intelligent electronic device, and the virtual reality telescopic observation system comprising an electronic device, an engagement slot and a virtual reality telescopic optical module, and the method comprising the steps of:
using a computing unit of the electronic device to combine at least one panoramic image, at least one virtual object image, at least one real image or any combination thereof in a computing database of the electronic device to perform a graphic computation to create a virtual image;
using a display unit of the electronic device to display the virtual image that is computed by the computing unit, and project the virtual image into the virtual reality telescopic optical module to allow a viewer to view the virtual image from the virtual reality telescopic optical module;
using at least one sensing unit of the electronic device to sense posture information, direction information, position information or any combination thereof of the viewer when the viewer performs a virtual reality telescopic observation, and transmit the information to the computing unit, such that the computing unit compares the relative positions between the viewer and the virtual image, so as to generate a relative position condition of the virtual image; and
using the computing unit to adjust the angle, distance and position of the virtual image with respect to the viewer according to the relative position condition when the viewer changes the field of view, and then using the display unit of the electronic device to display the virtual image adjusted by the computing unit, so that the viewer views the adjusted virtual image from the virtual reality telescopic optical module.

9. The virtual reality telescopic observation method of an intelligent electronic device as recited in claim 8, wherein the at least one sensing unit comprises a posture sensor, a direction sensor, a position sensor or any combination thereof, and the posture sensor is provided for sensing the posture information of the viewer, and the direction sensor is provided for sensing the direction information of the viewer, and the position sensor is provided for sensing the position information of the viewer.

10. The virtual reality telescopic observation method of an intelligent electronic device as recited in claim 8, wherein the posture information, the direction information, the position information, or any combination thereof in the computing database to be computed are transmitted to a remote database server synchronously via a wireless transmission, and received synchronously by the computing database via the wireless transmission when the computing is finished by the remote database server, and the virtual image computed by the remote database server is saved into the computing database.

11. The virtual reality telescopic observation method of an intelligent electronic device as recited in claim 8, wherein the virtual reality telescopic optical module further comprises at least one optical path adjusting element arranged for expanding or reducing the distance between optical axes of left and right eyes of the viewer in order to match the distance between the left and right eyes of the viewer.

12. The virtual reality telescopic observation method of an intelligent electronic device as recited in claim 8, wherein the virtual reality telescopic optical module further comprising at least one optical reflecting element arranged for decreasing the distance between the electronic device and the viewer, such that the center of gravity of the virtual reality telescopic observation system of the intelligent electronic device approaches the geometric center of the virtual reality telescopic observation system of the intelligent electronic device.

13. The virtual reality telescopic observation method of an intelligent electronic device as recited in claim 8, wherein the virtual reality telescopic optical module further comprising a beamsplitter provided for entering a real image into the virtual reality telescopic optical module, such that the real image is combined with a virtual object image to form the virtual image, so as to provide a visual effect of showing the virtual object image on the real image to the viewer.
